(19) United States
(12) Patent Application Publication
(10) Pub. No.: US 2024/0073610 A1
(43) Pub. Date: Feb. 29, 2024

(54) MICROPHONE CHIP AND MICROPHONE

(71) Applicant: AAC ACOUSTIC TECHNOLOGIES (SHENZHEN) CO., LTD., Shenzhen (CN)

(72) Inventors: Kaijie Wang, Shenzhen (CN); Zhuanzhuan Zhao, Shenzhen (CN); Linlin Wang, Shenzhen (CN)

(21) Appl. No.: 18/072,657

(22) Filed: Nov. 30, 2022

Related U.S. Application Data
(63) Continuation of application No. PCT/CN2022/119520, filed on Sep. 19, 2022.

(30) Foreign Application Priority Data
Aug. 26, 2022 (CN) 202222267738.7

(51) Int. Cl. H04R 7/14; H04R 1/08

(52) U.S. Cl. CPC H04R 7/14; H04R 1/083; H04R 2410/07

(57) ABSTRACT

A microphone chip and a microphone are provided. The microphone chip includes a diaphragm and a back plate. When the sound wave drives the diaphragm to vibrate through the sound hole, a distance between the electrode sheet and the diaphragm changes, and a capacitance value of the capacitance system changes, thereby converting the sound wave signal into an electrical signal. In the direction perpendicular to the back plate, the outer contour of the projection of each protrusion on the diaphragm and an outer contour of a corresponding fold of the plurality of folds do not intersect, so as to prevent the protrusion from contacting and getting stuck with the side wall of the fold in the process of external vibration or excessive blowing, which may lead to adhesion between the diaphragm and the back plate and affection of the normal operation of the microphone chip.

### CROSS REFERENCE TO RELATED APPLICATIONS

The present application is a continuation of PCT Patent Application No. PCT/CN2022/119520, filed Sep. 19, 2022, which claims priority to Chinese patent application No. 202222267738.7, filed Aug. 26, 2022, each of which is incorporated by reference herein in its entirety.

### TECHNICAL FIELD

The disclosure relates in general to the technical field of microphones, in particular to a microphone chip and a microphone.

### BACKGROUND

The existing microphone chip generally include a back plate, a diaphragm, and a substrate. The back plate and the diaphragm are both fixed on the substrate. The diaphragm is provided with folds for reducing rigidity of the diaphragm, and the back plate is provided with protrusions for preventing adsorption between the diaphragm and the back plate. Since part of the protrusions correspond to edges of the folds, the protrusions may be stuck with folds of the diaphragm in the process of external vibration or excessive blowing, thus affecting operation of the microphone chip.

### SUMMARY

Embodiments of the disclosure aim to provide a microphone chip and a microphone, which can solve problems that the protrusions are easy to get stuck with folds of the diaphragm.

Embodiments of the disclosure provide a microphone chip. The microphone chip includes a diaphragm and a back plate. The diaphragm is provided with a plurality of folds. The back plate is provided with at least one protrusion on a side of the back plate close to the diaphragm. In a direction perpendicular to the back plate, and an outer contour of a projection of each of the at least one protrusion on the diaphragm and an outer contour of a corresponding fold of the plurality of folds do not intersect.

In some embodiments, in the direction perpendicular to the back plate, the projection of the each of the at least one protrusion on the diaphragm is located between a corresponding pair of adjacent folds of the plurality of folds.

In some embodiments, in the direction perpendicular to the back plate, the projection of the each of the at least one protrusion on the diaphragm is located in the corresponding fold.

In some embodiments, each of the at least one protrusion has a width D1 in a range of 0.1 μm to 5 μm.

In some embodiments, each of the plurality of the folds has a width D2 in a range of 1 μm to 20 μm.

In some embodiments, the plurality of the folds are arranged in a circumferential direction of the diaphragm, and a center of each of the plurality of the folds coincides with a center of the diaphragm.

In some embodiments, each of the plurality of the folds has a circular or polygonal shape.

In some embodiments, the at least one protrusion is configured as a plurality of protrusions, and a distance L between adjacent protrusions is in a range of 10 μm to 100 μm.

In some embodiments, each of the at least one protrusion has a height H in a range of 0.1 μm to 5 μm.

In some embodiments, the microphone chip further includes a substrate, and the back plate and the diaphragm are both fixedly connected with the substrate.

Embodiments of the disclosure further provide a microphone. The microphone includes a main body and the microphone chip described in any aspect described above, where the microphone chip is provided on the main body.

The disclosure has following beneficial effects. In the direction perpendicular to the back plate, the outer contour of the projection of each of the at least one protrusion on the diaphragm and the outer contour of the corresponding fold do not intersect, thereby preventing the protrusion from contacting and getting stuck with the side wall of the fold in the process of external vibration or excessive air blowing, resulting in adhesion between the diaphragm and the back plate and affecting the normal operation of the microphone chip. Specifically, the side of the back plate close to the diaphragm is provided with an electrode sheet, and the side of the diaphragm close to the back plate is also provided with an electrode, so that the electrode sheet and the diaphragm form a capacitance system. At least one sound hole is defined on the back plate. When the sound wave drives the diaphragm to vibrate through the sound hole, the distance between the electrode sheet and the diaphragm changes, and the capacitance value of the capacitance system changes, thereby converting the sound wave signal into the electrical signal. In addition, the folds on the diaphragm can reduce the rigidity of the diaphragm, improve the flexibility of the diaphragm, and make the diaphragm more sensitive to sound waves, thereby improving the accuracy of the microphone chip converting sound waves into electrical signals.

It can be understood that the above general description and the following detailed description are exemplary only and are not limiting to the disclosure.

### BRIEF DESCRIPTION OF THE DRAWINGS

FIG. 1 is a schematic structural diagram of a microphone chip according to embodiments of the disclosure.

FIG. 2 is a cross-sectional view of FIG. 1.

FIG. 3 is a partial enlarged view of part A in FIG. 2.

FIG. 4 is a top view of the microphone chip of FIG. 1 without a back plate and an electrode sheet.

Reference numerals in figures are illustrated as follows:
1: back plate; 11: sound hole; 2: electrode sheet; 3: protrusion; 4: diaphragm; 41: fold; 5: substrate.

The accompanying drawings which are incorporated in and constitute a part of the specification illustrate embodiments consistent with the disclosure and together with the description serve to explain the principles of the disclosure.

### DETAILED DESCRIPTION OF THE EMBODIMENTS

To better understand technical solutions of the disclosure, embodiments of the disclosure are described in detail below with reference to the accompanying drawings.

It should be made clear that the described embodiments are only part of embodiments and not all embodiments of the disclosure. Based on the embodiments in the disclosure, all other embodiments obtained without creative effort by those of ordinary skill in the art fall within the scope of protection of the disclosure.

Terms used in embodiments of the disclosure are for the purpose of describing specific embodiments only and are not intended to limit the disclosure. Singular forms “an”, “said”, and “the” as used in embodiments of the disclosure and in the appended claims are also intended to include a plurality of forms, unless the context clearly dictates otherwise.

It can be understood that the term “and/or” used herein is merely an association relationship that describes an associated object, indicating that there can be three relationships. For example, the expression “A and/or B” may include three cases: A exists alone, A and B exist at the same time, and B exists alone. In addition, the character “/” herein generally indicates that related objects are a kind of “or” relationship.

It is to be noted that the orientation words “up”, “down”, “left”, “right”, and the like described in the embodiments of the disclosure are described from the angles shown in the drawings and should not be understood as limiting the embodiments of the disclosure. Furthermore, in the context, it is to be understood that when a component is referred to as being connected “above/up” or “below/lower” of another component, the component can not only be directly connected to the “above/up” or “below/lower” of the another component, but can also be indirectly connected to the “above/up” or “below/lower” of the another component through a middle component.

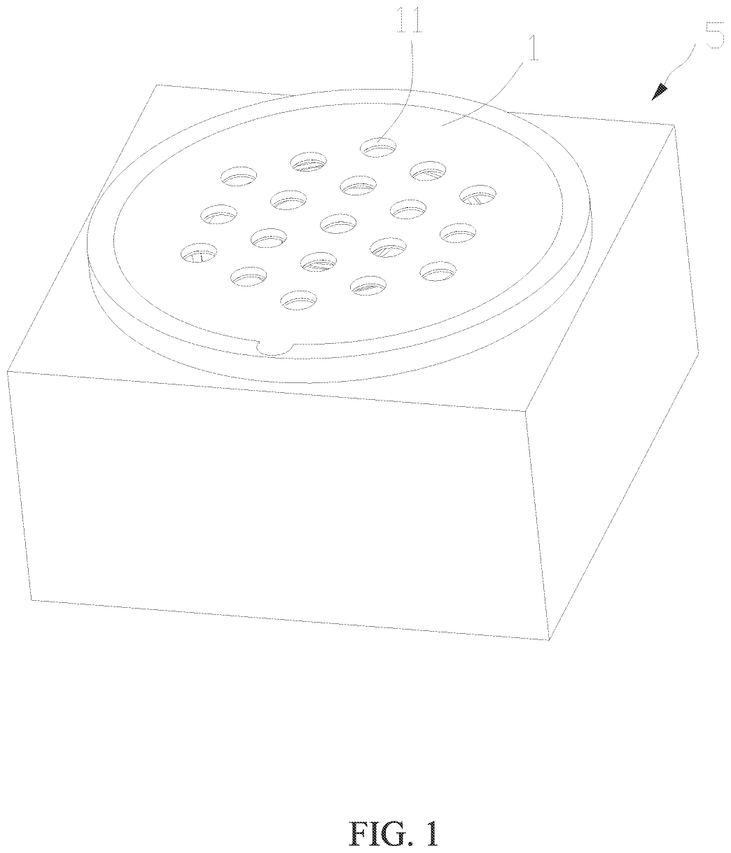

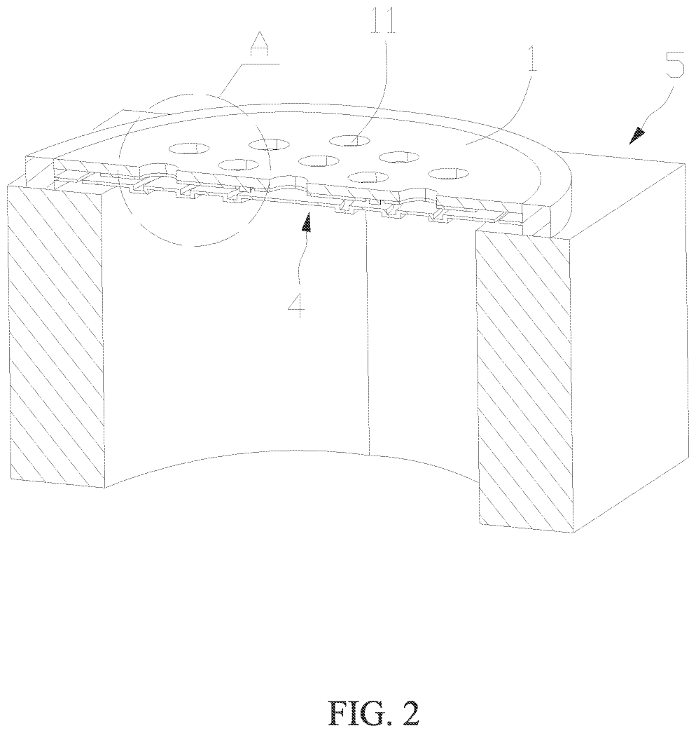

The disclosure provides a microphone chip which solves the problem that protrusions are easy to be stuck with folds of a diaphragm. As illustrated in FIG. 1 to FIG. 4, the microphone chip includes a diaphragm 4 and a back plate 1. The diaphragm 4 is provided with a plurality of folds 41, and the back plate 1 is provided with at least one protrusion 3 on a side of the back plate 1 close to the diaphragm 4. In a direction perpendicular to the back plate 1, an outer contour of a projection of each of the at least one protrusion 3 on the diaphragm 4 and an outer contour of a corresponding fold 41 of the plurality of folds 41 do not intersect.

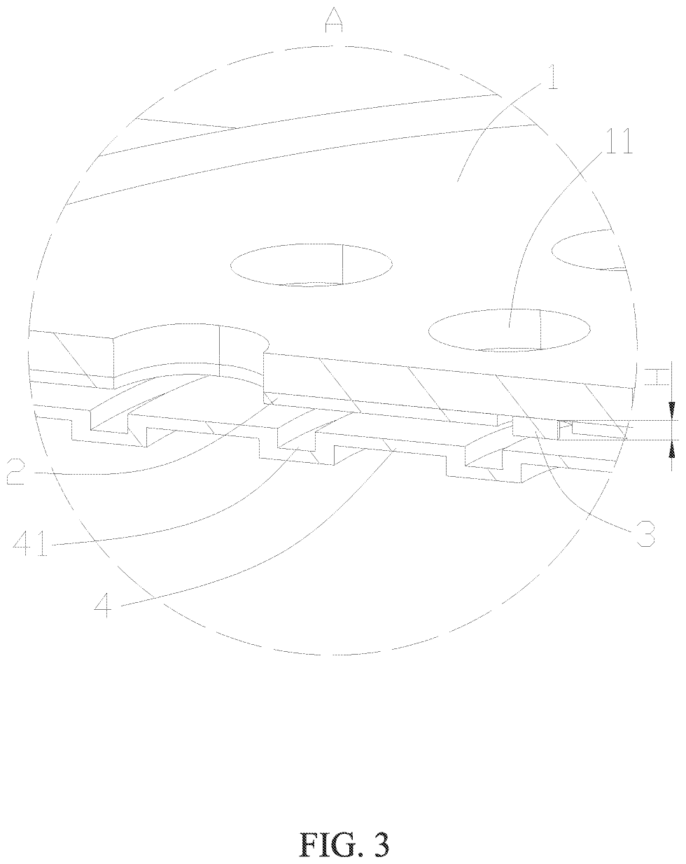

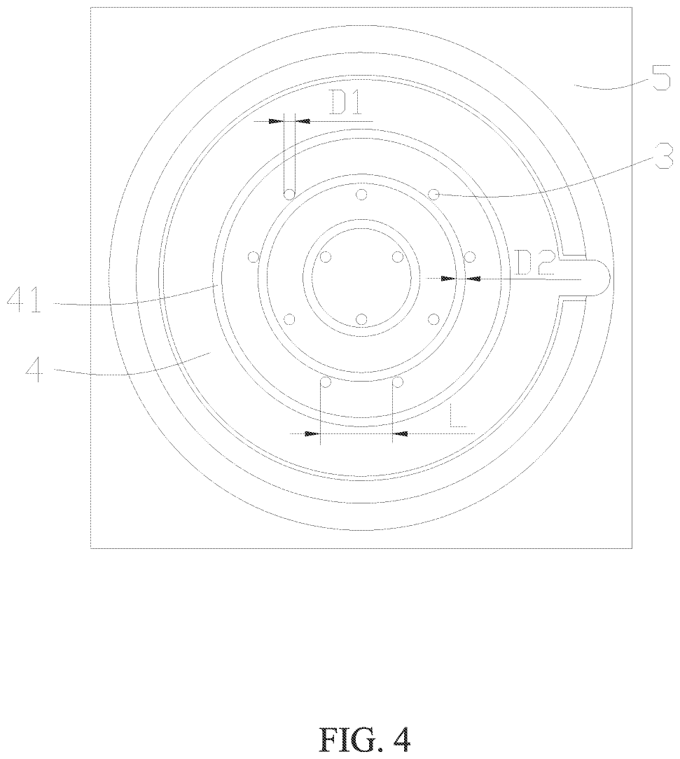

In embodiments, as illustrated in FIGS. 3 and 4, in the direction perpendicular to the back plate 1, the outer contour of the projection of each of the at least one protrusion 3 on the diaphragm 4 and the outer contour of the corresponding fold 41 of the plurality of folds 41 do not intersect, which can prevent the protrusion 3 from contacting and getting stuck with a side wall of the fold 41 during external vibration or excessive blowing, thereby avoiding the diaphragm 4 not to be adhered to the back plate 1 and thus avoiding affecting the normal operation of the microphone chip.

Specifically, the back plate 1 is provided with at least one electrode sheet 2 on a side close to the diaphragm 4, and the diaphragm 4 is also provided with an electrode on a side close to the back plate 1, so that the electrode sheet 2 and the diaphragm 4 form a capacitive system. At least one sound hole 11 is defined on the back plate 1. When sound waves drive the diaphragm 4 to vibrate through the sound hole 11, a distance between the electrode sheet 2 and the diaphragm 4 changes, and a capacitance value of the capacitance system changes, thereby converting the sound wave signal into an electrical signal. In addition, the folds 41 on the diaphragm 4 can reduce rigidity of the diaphragm 4, improve flexibility of the diaphragm 4, and make the diaphragm 4 more sensitive to sound waves, thereby improving accuracy of the microphone chip converting sound waves into electrical signals.

Further, the at least one protrusion 3 and the back plate 1 are integrally formed, or the at least one protrusion 3 may be connected to the back plate 1 through bonding or the like. The microphone chip further includes a substrate 5, and the back plate 1 and the diaphragm 4 are both fixedly connected with the substrate 5.

In some embodiments, as illustrated in FIG. 4, in the direction perpendicular to the back plate 1, the projection of each of the at least one protrusion 3 on the diaphragm 4 is located between a corresponding pair of adjacent folds 41 of the plurality of folds 41.

In the disclosure, as illustrated in FIG. 4, when the projection of each of the at least one protrusion 3 on the diaphragm 4 is located between the corresponding pair of adjacent folds 41 of the plurality of folds 41, the protrusion 3 is not easy to contact and get stuck with a side wall of the fold 41, and the protrusion 3 can prevent the diaphragm 4 from contacting with the back plate 1, thereby ensuring the normal operation of the microphone chip.

In some embodiments, the projection of each of the at least one protrusion 3 on the diaphragm 4 is located in the corresponding fold 41 in the direction perpendicular to the back plate 1.

In embodiments, the fold 41 covers the projection of the protrusion 3 on the diaphragm 4, that is, the projection of the protrusion 3 on the diaphragm 4 completely coincides with a bottom wall of the fold 41. The protrusion 3 does not come into contact with the side wall of the fold 41 in the process of external vibration or excessive air blowing, so as to prevent the protrusion 3 from getting stuck with the fold 41, thereby ensuring the reliability of operation of the microphone chip.

In some embodiments, as illustrated in FIG. 4, a width D1 of each of at least one protrusion 3 ranges from 0.1 μm to 5 μm (0.1 μm≤D1≤5 μm). For example, D1 may be 0.1 μm, 1 μm, 2 μm, 3 μm, 5 μm, and the like.

In embodiments, as illustrated in FIG. 4, the width D1 of the protrusion 3 should not be too large or too small. If the width D1 of the protrusion 3 is too large (for example, greater than 5 μm), the protrusion 3 reduces a space range in which the diaphragm 4 can move and affects the operation of the microphone chip. If a width D1 of the protrusion 3 is too small (for example, less than 0.1 μm), an area where the protrusion 3 can contact the diaphragm 4 is too small to effectively prevent the diaphragm 3 from contacting the electrode sheet 2 on the back plate 1, thereby causing a short circuit and thereby affecting the operation of the microphone chip. Therefore, the diaphragm 4 can be effectively prevented from contacting the electrode sheet 2 on the back plate 1 while guaranteeing a large movement range for the diaphragm 4 only if the width D1 of each protrusion 3 ranges from 0.1 μm to 5 μm (0.1 μm≤D1≤5 μm).

In some embodiments, as illustrated in FIG. 4, a width D2 of the fold 41 ranges from 1 μm to 20 μm (1 μm≤D2≤20 μm). For example, D2 may be 1 μm, 5 μm, 10 μm, 15 μm, 20 μm, and the like.

In embodiments, as illustrated in FIG. 4, the width D2 of the fold 41 should not be too large or too small. If the width D2 of the fold 41 is too large (for example, greater than 20 μm), the rigidity of the fold 41 to the diaphragm 4 may be reduced too much, which may make the diaphragm 4 too soft. Under the action of sound waves, a movement amplitude of the diaphragm 4 may be too large, and the number of times the diaphragm 4 contacts with the protrusion 3 will be too large, which may affect the accuracy of the microphone chip converting sound waves into electrical signals. On the contrary, if the width D2 of the fold 41 is too small (for example, less than 1 μm), the rigidity of the diaphragm 4 is large, and the movement amplitude of the diaphragm 4 under the action of sound waves is too small, which may affect the accuracy of the microphone chip converting sound waves into electrical signals. Therefore, only when the width D2 of the fold 41 satisfies that 1 μm≤D2≤20 μm, can it be ensured that the movement range of the diaphragm 4 can accurately convert the acoustic signal into an electrical signal under the action of sound waves.

In some embodiments, as illustrated in FIG. 4, the plurality of folds 41 are arranged in a circumferential direction of the diaphragm 4, and a center of each of the plurality of folds 41 coincides with a center of the diaphragm 4.

In embodiments, as illustrated in FIG. 4, the plurality of folds 41 are arranged in the circumferential direction of the diaphragm 4, and the center of each of the plurality of folds 41 coincides with the center of the diaphragm 4, so that the rigidity at different positions on the diaphragm 4 is close, and the displacement at different positions of the diaphragm 4 moving under the action of sound waves is close, so that the microphone chip has better effect of converting the sound wave signals into the electrical signals.

In some embodiments, as illustrated in FIG. 4, the plurality of folds 41 each have a circular or polygonal shape.

In embodiments, as illustrated in FIG. 4, the shape of the fold 41 may be set to have a circular or polygonal shape, or other shapes. Specifically, when the diaphragm 4 have a circular shape, the fold 41 can be arranged in a circular shape, so that more fold 41 can be arranged on the diaphragm 4, and the movement of the diaphragm 4 under the action of sound waves is more symmetrical. Similarly, when the diaphragm 4 has a regular hexagonal shape, the fold 41 may also be arranged in a regular hexagonal shape or a circular shape.

In some embodiments, as illustrated in FIG. 4, the at least one protrusion 3 is configured as a plurality of protrusions 3, and a distance L between adjacent protrusions 3 is in a range of 10 μm to 100 μm (10 μm≤100 μm). For example, L may be specifically 10 μm, 30 μm, 60 μm, 80 μm, 100 μm, and the like.

In embodiments, as illustrated in FIG. 4, the distance L between the adjacent protrusions 3 should not be too large or too small. If the distance L between the adjacent protrusions 3 is too large (for example, greater than 100 μm), the protrusions 3 cannot effectively prevent the diaphragm 4 from contacting the electrode sheet 2 on the back plate 1, thereby causing a short circuit and affecting the operation of the microphone chip. On the contrary, if the distance L between adjacent protrusions 3 is too small (for example, less than 10 μm), the protrusions 3 reduce the space range within which the diaphragm 4 can move and affect the operation of the microphone chip. Therefore, the diaphragm 4 can be effectively prevented from contacting the electrode sheet 2 on the back plate 1 while keeping a large movement space for the diaphragm 4, only when the distance L between the adjacent protrusions 3 satisfies the requirement of 10 μmL100 μm.

In some embodiments, as illustrated in FIG. 3, a height H of each of the at least one protrusion 3 is in a range of 0.1 μm to 5 μm (i.e., 0.1 μmH5 μm). For example, H may be 0.1 μm, 1 μm, 2 μm, 3 μm, 5 μm, and the like.

In embodiments, as illustrated in FIG. 3, the height H of each of the at least one protrusion 3 should not be too large or too small. If the height H of the protrusion 3 is too large (for example, greater than 5 μm), the protrusion 3 reduces the space range in which the diaphragm 4 can move and affects the operation of the microphone chip. On the contrary, if the height H of the protrusion 3 is too small (for example, less than 0.1 μm), the protrusion 3 cannot effectively prevent the diaphragm 3 from contacting the electrode sheet 2 on the back plate 1, which may easily cause a short circuit and further affect the operation of the microphone chip. Therefore, the diaphragm 4 can be effectively prevented from contacting the electrode sheet 2 on the back plate 1 while keeping a large movement space for the diaphragm 4, only when the height H of the protrusion 3 satisfies 0.1 μm≤H≤5 μm.

Embodiments of the disclosure further provide a microphone. The microphone includes a main body and a microphone chip. The microphone chip is arranged on the main body. In embodiments, the microphone provided with the microphone chip provided in the disclosure has a relatively higher reliability during operating, is not easy to be damaged, and has good use experience for users.

The foregoing merely describes some embodiments of the disclosure. It is to be noted that improvements may be made to those of ordinary skill in the art without departing from the inventive idea of the disclosure, but these are within the scope of protection of the disclosure.

What is claimed is:

1. A microphone chip, comprising:
a diaphragm, wherein the diaphragm is provided with a plurality of folds; and
a back plate, wherein the back plate is provided with at least one protrusion on a side of the back plate close to the diaphragm, wherein in a direction perpendicular to the back plate, and an outer contour of a projection of each of the at least one protrusion on the diaphragm and an outer contour of a corresponding fold of the plurality of folds do not intersect.

2. The microphone chip of claim 1, wherein in the direction perpendicular to the back plate, the projection of the each of the at least one protrusion on the diaphragm is located between a corresponding pair of adjacent folds of the plurality of folds.

3. The microphone chip of claim 1, wherein in the direction perpendicular to the back plate, the projection of the each of the at least one protrusion on the diaphragm is located in the corresponding fold.

4. The microphone chip of claim 1, wherein each of the at least one protrusion has a width D1 in a range of 0.1 μm to 5 μm.

5. The microphone chip of claim 1, wherein each of the plurality of the folds has a width D2 in a range of 1 μm to 20 μm.

6. The microphone chip of claim 1, wherein the plurality of the folds are arranged in a circumferential direction of the diaphragm, and a center of each of the plurality of the folds coincides with a center of the diaphragm.

7. The microphone chip of claim 1, wherein each of the plurality of the folds has a circular or polygonal shape.

8. The microphone chip of claim 1, wherein the at least one protrusion is configured as a plurality of protrusions, and a distance L between adjacent protrusions is in a range of 10 μm to 100 μm.

9. The microphone chip of claim 1, wherein each of the at least one protrusion has a height H in a range of 0.1 μm to 5 μm.

10. The microphone chip of claim 1, wherein the microphone chip further comprises a substrate, and the back plate and the diaphragm are both fixedly connected with the substrate.

11. A microphone, comprising a main body and a microphone chip, wherein the microphone chip is provided on the main body, wherein
the microphone chip comprises:
a diaphragm, wherein the diaphragm is provided with a plurality of folds; and
a back plate, wherein the back plate is provided with at least one protrusion on a side of the back plate close to the diaphragm, wherein in a direction perpendicular to the back plate, and an outer contour of a projection of each of the at least one protrusion on the diaphragm and an outer contour of a corresponding fold of the plurality of folds do not intersect.

12. The microphone of claim 11, wherein in the direction perpendicular to the back plate, the projection of the each of the at least one protrusion on the diaphragm is located between a corresponding pair of adjacent folds of the plurality of folds.

13. The microphone of claim 11, wherein in the direction perpendicular to the back plate, the projection of the each of the at least one protrusion on the diaphragm is located in the corresponding fold.

14. The microphone of claim 11, wherein each of the at least one protrusion has a width D1 in a range of 0.1 μm to 5 μm.

15. The microphone of claim 11, wherein each of the plurality of the folds has a width D2 in a range of 1 μm to 20 μm.

16. The microphone of claim 11, wherein the plurality of the folds are arranged in a circumferential direction of the diaphragm, and a center of each of the plurality of the folds coincides with a center of the diaphragm.

17. The microphone of claim 11, wherein each of the plurality of the folds has a circular or polygonal shape.

18. The microphone of claim 11, wherein the at least one protrusion is configured as a plurality of protrusions, and a distance L between adjacent protrusions is in a range of 10 μm to 100 μm.

19. The microphone of claim 11, wherein each of the at least one protrusion has a height H in a range of 0.1 μm to 5 μm.

20. The microphone of claim 12, wherein the at least one protrusion is configured as a plurality of protrusions, and a distance L between adjacent protrusions is in a range of 10 μm to 100 μm, and each of the at least one protrusion has a height H in a range of 0.1 μm to 5 μm.
